(19) United States
(12) Patent Application Publication
(10) Pub. No.: US 2009/0129773 A1
(43) Pub. Date: May 21, 2009

(54) Method and apparatus for isolating a location of a fault in a passive optical network

(76) Inventor: Moshe Oron, San Rafael, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/986,418

(22) Filed: Nov. 21, 2007

(51) Int. Cl. H04B 10/08; H04B 17/00

(52) U.S. Cl. 398/10

(57) ABSTRACT

A method and apparatus of isolating a location of a fault in an optical network may include using communications traffic signals and network nodes to determine excess power losses without interrupting service or requiring additional external test equipment. A transmit optical network node is configured to measure the transmit power of multiple wavelengths of a transmitted optical signal. A receive optical network node is configured to measure the receive power of the same multiple wavelengths. Power differentials of the transmit and receive optical power for each wavelength may be calculated. Optical power losses as a function of the optical path distance between the transmit and receive optical network nodes my be determined. The data may be used to isolate the location of a fault in a passive optical network based on the differences between the optical power losses of the multiple wavelengths thereby reducing troubleshooting time and network downtime.

### BACKGROUND OF THE INVENTION

A passive optical network (PON) uses optical fiber links to communicate data, video, or audio (herein collectively “data”) between network nodes. As demand for communication services has increased, system operators have increasingly deployed point-to-multipoint PONs. Within PONs, components such as optical splitter/combiners (OSC) passively split an optical signal into identical power reduced copies, allowing a single fiber connection to be shared among multiple users. A limited number of OSCs may be used because optical signal power drops each time the signal is split. Thus, a typical PON may use one OSC or perhaps cascade two OSCs. Using such an architecture, point-to-multipoint PONs allow a service provider to serve more customers with less equipment, thereby decreasing equipment cost on a per user basis.

In a PON, data embedded in a light signal generated by, for example, a laser diode, flows downstream from a transmitting network node, such as an optical line terminal (OLT) to a receiving optical network node, such as an optical network unit (ONU) or optical network terminal (ONT). The same downstream signal flows to all the ONUs but each ONU only processes data intended for that particular ONU based on, for example, an identification field unique to that ONU or ONT.

Each ONU may also transmit different upstream signals that are passively combined at the OSC and thereafter further flow to the OLT. To prevent the individual ONU signals from interfering or colliding with each other, the signals are carefully combined using, for example, a time division multiple access (TDMA) multiplexing technique, where each ONU is assigned a unique time slot in the combined upstream optical signal. A ranging process is used to determine the ‘logical’ distance in order to determine when each ONU should begin transmission of its data in an upstream direction.

The complexity of a multipoint PON architecture, together with a system operator's interest in avoiding customer service interruptions, has increased difficulty of diagnosing and troubleshooting network problems, resulting in increased maintenance and operation costs.

### SUMMARY OF THE INVENTION

An example method and corresponding apparatus for isolating a fault in an optical network may include calculating power differentials between transmitted optical powers of multiple wavelengths and received optical powers of the same multiple wavelengths to produce calculated power differentials. The transmitted optical powers may be measured at a transmitting optical network node, and the received optical powers may be measured at a receiving optical network node in communication with the transmitting optical network node via at least one optical path in an optical network. The example method may further include determining optical power losses based on a combination of the calculated power differentials and fiber attenuation as a function of an optical path distance between the transmitting and receiving optical network nodes for the multiple wavelengths. A location of a fault in the optical network may be isolated based on differences between the optical power losses of the multiple wavelengths and may be reported to, for example, a system operator.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating example embodiments of the present invention.

FIG. 1 is a network diagram of an example passive optical network (PON);

FIG. 2 is a network diagram of an example portion of a network in which optical elements are configured to determine optical signal power loss in accordance with one embodiment of the present invention;

FIG. 3 is a network diagram of an example portion of a PON in which an Optical Line Terminal (OLT) is configured to determine optical signal power loss between the OLT and an Optical Network Unit (ONU) using measurements on a multiple wavelengths of a downstream optical signal;

FIG. 4 is a network diagram of an example portion of a PON in which an OLT is configured to determine optical signal power loss between the OLT and an ONU using an upstream optical signal;

FIG. 5 is a network diagram of an example portion of a network in which an ONU is configured to determine optical signal power loss between the ONU and an OLT using measurements of multiple wavelengths of upstream and downstream optical signal;

FIG. 6 is a network diagram of an example portion of a PON illustrating in further detail an optical path distance determination unit;

FIG. 7 is a flow diagram performed in accordance with an example embodiment of the invention;

FIG. 8 is a flow diagram performed in accordance with an example embodiment of the invention;

FIG. 9 is a flow diagram performed in accordance with an example embodiment of the invention; and

FIG. 10 is a flow diagram illustrating locating a fault in a PON in accordance with an example embodiment of the invention.

### DETAILED DESCRIPTION OF THE INVENTION

A description of example embodiments of the invention follows.

Early implementations of optical networks were deployed as point-to-point networks. With single end nodes, it is relatively easy to determine operating characteristics of the optical link, such as excess optical signal power loss. Troubleshooting and isolating the location of a fault in point-to-point optical networks is also a relatively straightforward process as there are only two network nodes and one or two communication paths. As service demands have increased, network providers have begun deploying point-to-multipoint passive optical network (PON) architectures.

The PON architecture allows a service provider to serve multiple users with less equipment and fiber as compared with equivalent point-to-point architectures. Examples include asynchronous transfer mode (ATM) PONs (APON), broadband PONs (BPON), and more recently Ethernet PONs (EPON), as described in the Institute of Electrical and Electronics Engineers (IEEE) 802.3ah standard, and gigabit PONs (GPON) as described in the International Telecommunications Union-Telecommunication (ITU-T) G.984 standard. However, because there are many more network nodes and associated fiber links located in different physical locations, point-to-multipoint PONs are more difficult to troubleshoot and isolate service problems that inevitably occur.

During the installation of a PON, skilled technicians with specialized test equipment verify that the optical distribution network is properly deployed and meets intended performance operating characteristics. This process is conducted before the service is provided to customers, i.e., during an out-of-service period. After installation, test equipment is typically removed, network nodes are installed, and service is brought on-line.

If service at one of the network nodes, such as an optical network unit (ONU) or optical network terminal (ONT), begins to malfunction, customers associated with an aberrant branch or path of the PON may experience intermittent or complete service interruptions. (Note that an ONU and an ONT may be used interchangeably herein unless indicated otherwise.) A skilled technician, equipped with specialized test equipment, may be dispatched to various locations to isolate, troubleshoot, and repair the problem, and may also have to stop and restart network communications—typically an expensive and time consuming process. Optical path measurements may be performed to help isolate and locate a variety of service problems. In addition, optical power measurements may also be performed to ensure the optical path is operating properly and ready to be put back into service.

Service problems may be due to optical fiber degradation that occurs over time (e.g., fiber aging), physical fiber problems (e.g., excessive fiber bending), or electronic component issues (e.g., ONU or OLT malfunctioning). An ability to conduct in-service optical measurements may provide valuable information to allow a service provider to quickly and more cost effectively isolate the location of a fault within the PON. However, once service is enabled, it becomes much more difficult to perform these measurements in the PON (e.g., excess signal power loss) using existing troubleshooting methods for a number of reasons. Current methods of measuring excess signal power loss and fault isolation may require detrimentally halting network service, installing specialized test equipment, such as optical power meters and optical time domain reflectometers, and performing multiple measurement at a number of different locations, resulting in system downtime, additional operating costs, and undesirable service interruptions.

Alternative existing methods may include leaving a number connections attached to the PON and connecting test equipment in the field to perform optical signal power loss measurements, which may include using non-traffic bearing wavelengths to communicate specific, non-traffic bearing test signals. However, the additional test equipment and labor costs can increase operational expenses. The additional test equipment necessarily includes additional connectors, which may adversely impact the PON's power budget, potentially decreasing the number of network nodes, and ultimately customers, a system operator is able to serve. Furthermore, these methods may not provide information indicative of the location of a fault in the PON.

According to some embodiments of the present invention, a PON is able to determine optical signal power loss and isolate a location of a fault in the PON while the network is in-service, without additional test equipment or connectors. The example embodiments take advantage of the fact that current OLTs and ONUs now have the ability to measure the transmit and receive optical power of the optical signal of individual wavelengths transmitted on a fiber. Together with optical path distance, such as distance able to be determined using existing ranging data, optical signal power loss may be determined for each wavelength, and the relative losses at multiple wavelengths may be used to provide an indication of the location of a network fault, such as fiber or component problems in the PON. Note that wavelength as used herein refers to an optical signal having a given wavelength (e.g., 1310 nanometers (nm), 1490 nm, or 1550 nm).

An example method and corresponding apparatus for isolating a fault in an optical network may include calculating power differentials between transmitted optical powers of multiple wavelengths and received optical powers of the same multiple wavelengths to produce calculated power differentials. The transmitted optical powers may be measured at a transmitting optical network node, and the received optical powers may be measured at a receiving optical network node in communication with the transmitting optical network node via at least one optical path in an optical network. The example method may further include determining optical power losses based on a combination of the calculated power differentials and fiber attenuation as a function of an optical path distance between the transmitting and receiving optical network nodes for the multiple wavelengths. A location of a fault in the optical network may be isolated based on differences between the optical power losses of the multiple wavelengths and may be reported to, for example, a system operator. The differences may be based on, for example, comparing (or similar arithmetic operation) the optical power loss value of one wavelength against one of the following: an optical power loss value of another wavelength, average of at least two other wavelengths, predetermined value, operator provided value, stored value, calculated value, or similarly derived value.

Alternative example embodiments may include adjusting the calculated power differential to account for fixed power losses between the transmitting and receiving optical network nodes. Parameters related to the fixed power losses may be calculated, stored internally or externally, or provided by a user. The optical signal having multiple wavelengths may be a traffic signal carrying network communications or may be a specific test signal communicated for the purposes of measuring power losses.

According to some embodiments of the present invention, an optical path distance between the transmitting and receiving optical network nodes may be calculated based on ranging results and may further include removing propagation delays within the transmitting and receiving optical network nodes from the calculated distance result. Propagation delay parameters may be calculated, stored, measured, provided by a user or the like.

In other example embodiments, a representation of the received optical power measurement may be forwarded from the receiving network node to the transmitting network node, and the optical signal power loss is determined at the transmitting network node. Measurements, calculated results, or both, may be forwarded from the transmitting optical network node to a management node, server, service provider, or receiving optical network node.

In an alternative example embodiment, a representation of the transmitted optical power measurement may be forwarded from the transmitting network node to the receiving network node, and the optical signal power loss is determined at the receiving network node. Measurements, calculated results, or both, may be forwarded from the receiving optical network node to a management node, server, service provider, or transmitting optical network node.

Example embodiments may include monitoring for a change in the optical signal power loss over time or determining optical signal power loss periodically, on an on-demand basis, or on an event driven basis. Reporting may include alerting a service provider if the optical signal power loss exceeds a threshold, issuing an alarm, causing the transmitting or receiving optical network node to change states, issuing a command, issuing a notification, issuing a threshold crossing alert, reporting a measured result, reporting a calculated result, or reporting an average of the optical signal power loss for at least two wavelengths.

In the example embodiments, the transmitting optical network node may be an Optical Line Terminal (OLT), and the receiving optical network node may be an Optical Network Unit (ONU) downstream of the OLT. Alternatively, the transmitting optical network node may be an Optical Network Unit (ONU), and the receiving optical network node may be an Optical Line Terminal (OLT) upstream of the ONU.

In yet another example embodiment, isolating a location of a fault may include correlating signal power loss values for at least two of the multiple wavelengths. Alternatively, or in addition, isolating a location of a fault may further include correlating a signal power loss value of a wavelength against an average signal power loss value of at least two of the multiple wavelengths.

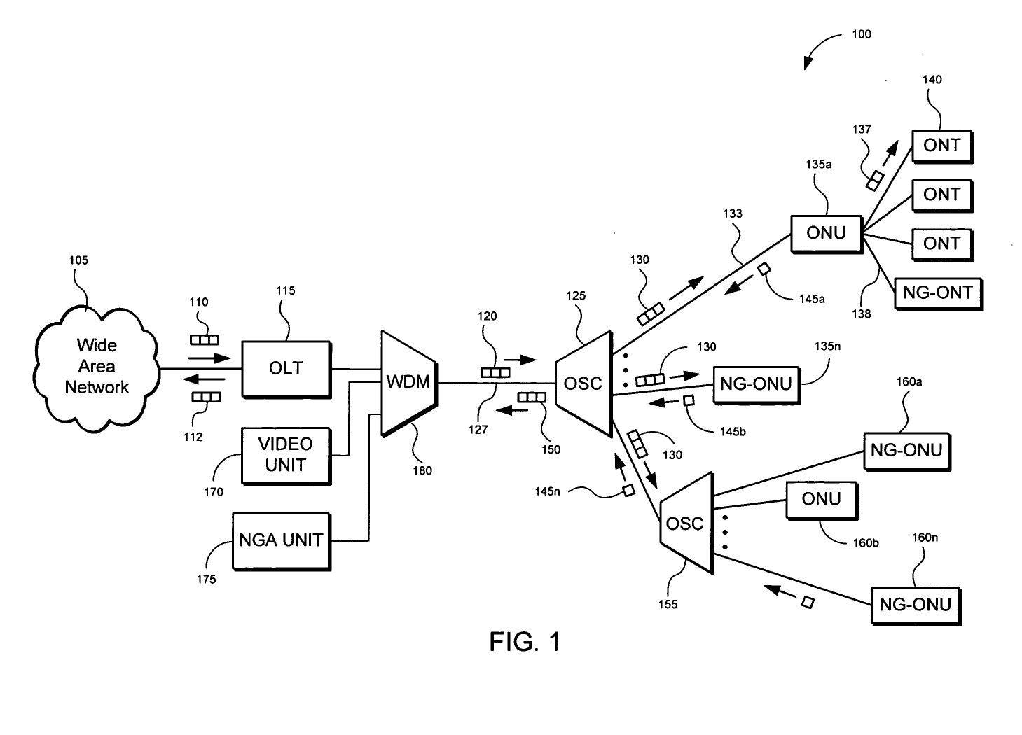

FIG. 1 is a network diagram of a passive optical network (PON) 100 illustrating aspects of an example embodiment of the invention. The PON 100 includes an optical line terminal (OLT) 115, a video unit 170, a next generation application (NGA) unit 175, an optical splitter/combiner (OSC) 125, and at least one optical network unit (ONU) 135a-n. The ONUs 135a-n may be in optical communication with multiple optical network terminals (ONTs) 140 directly in electrical communication with end user equipment, such as routers, telephones, home security systems, and so forth (not shown). In other network embodiments, the OLT 115 may be in direct optical communication with the ONTs 140. Data communications 110 may be transmitted to the OLT 115 from a wide area network (WAN) 105. “Data” as used herein refers to voice, video, analog, or digital data.

Communication of downstream signals 120 and upstream signals 150 transmitted between the OLT 115 and the ONUs 135a-n may be performed using standard communications protocols known in the art. For example, optical signals of multiple wavelengths may be multiplexed via a wavelength division multiplexing (WDM) device 180 in the downstream direction. On each wavelength, communications may be broadcast with identification (ID) data to identify intended recipients (e.g., the ONUs 135a-n) for transmitting the downstream signal 120 from the OLT 115 to the ONUs 135a-n, and time division multiple access (TDMA) for transmitting the upstream data 150 from an individual ONU 135a-n back to the OLT 115. Note that the downstream signal 120 is power divided by the OSC 125 into downstream signal 130 matching the downstream signal 120 “above” the OSC 125 but with power reduced proportionally to the number of paths onto which the OSC 125 divides the downstream signal 120. It should be understood that the terms downstream signal 120, 130 and upstream data 150 are optical traffic signals that typically travel via optical communications paths 127, 133, 138, such as optical fibers.

The PON 100 may be deployed for fiber-to-the-premise (FTTP), fiber-to-the-curb (FTTC), fiber-to-the-node (FTTN), and other fiber-to-the-X (FTTX) applications. The optical fiber 127 in the PON 100 may operate at bandwidths such as 155 megabits per second (Mbps), 622 Mbps, 1.25 gigabits per second (Gbps), and 2.5 Gbps or other bandwidth implementations. The PON 100 may incorporate asynchronous transfer mode (ATM) communications, broadband services such as Ethernet access and video distribution, Ethernet point-to-multipoint topologies, and native communications of data and time division multiplex (TDM) formats or other communications suitable for a PON 100. ONTs 140, may receive and provide communications to and from the PON 100 and may be connected to standard telephones (i.e., Public Switched Telephone Network), Internet Protocol telephones, Ethernet units, video devices, computer terminals, digital subscriber lines, wireless access, as well as any other conventional customer premise equipment.

The OLT 115, video unit 170, NGA unit 175 may generate, or pass through, downstream communications 110 from the WAN 105, video head-end (not shown) or other communications source to a WDM 180 where multiple wavelengths are multiplexed together and the resulting signal 120 is further communicated to an OSC 125. After flowing through the OSC 125, the downstream communications 120 are broadcast as power reduced downstream communications 130 to the ONUs 135a-n where each ONU 135a-n reads data 130 intended for that particular ONU 135a-n. The downstream communications 120 may also be broadcast to, for example, another OSC 155 where the downstream communications 120 are again split and broadcast to additional ONUs 160a-n and/or ONTs (not shown).

Data communications 137 may be further transmitted to and from, for example, an ONT 140 in the form of data, video, voice, and/or telemetry over copper, fiber, or other suitable connection 138 known to those skilled in the art. The ONUs 135a-n transmit upstream communication signals 145a-n back to the OSC 125 via fiber connections 133. The OSC 125, in turn, combines the ONU 135a-n upstream signals 145a-n and transmits a combined signal 150 back to the OLT 115 which, for example, may employ a TDM protocol to determine from which ONUs 135a-n portions of the combined signal 150 are received. The OLT 115 may further transmit the communication signals 112 to a WAN 105.

Communications between the OLT 115, video unit 170, NGA unit 175 and the ONUs 135a-n occur using multiple downstream wavelength multiplexing via the WDM 180 and communicated in a common optical signal over a common fiber 127. For example downstream OLT communications may use a wavelength of 1490 nm, Video communications may use a wavelength of 1550 nm, and NGA communications, such as those defined in draft recommendation International Telecommunications Union-Telecommunication (ITU-T) G.984.5, entitled “Enhancement band for Gigabit capable Optical Access Networks,” may use, for example, 3-4 wavelengths in the enhancement band between 1580-1625 nm. Upstream communications from the ONUs 135a-n, 160a-n may use a wavelength of 1310 nm. Thus, a PON may transport optical signals of multiple wavelengths (e.g., 6 or 7) on a single fiber flowing in both directions simultaneously.

For each wavelength the downstream communications 120 from the OLT 115 to the ONUs 135a-n may be provided at 2.488 Gbps, which is shared across all ONUs. The upstream communications 145a-n from the ONUs 135a-n to the OLT 115 may be provided at 1.244 Gbps, which is shared among all ONUs 135a-n connected to the OSC 125. Other communication data rates known in the art may also be employed.

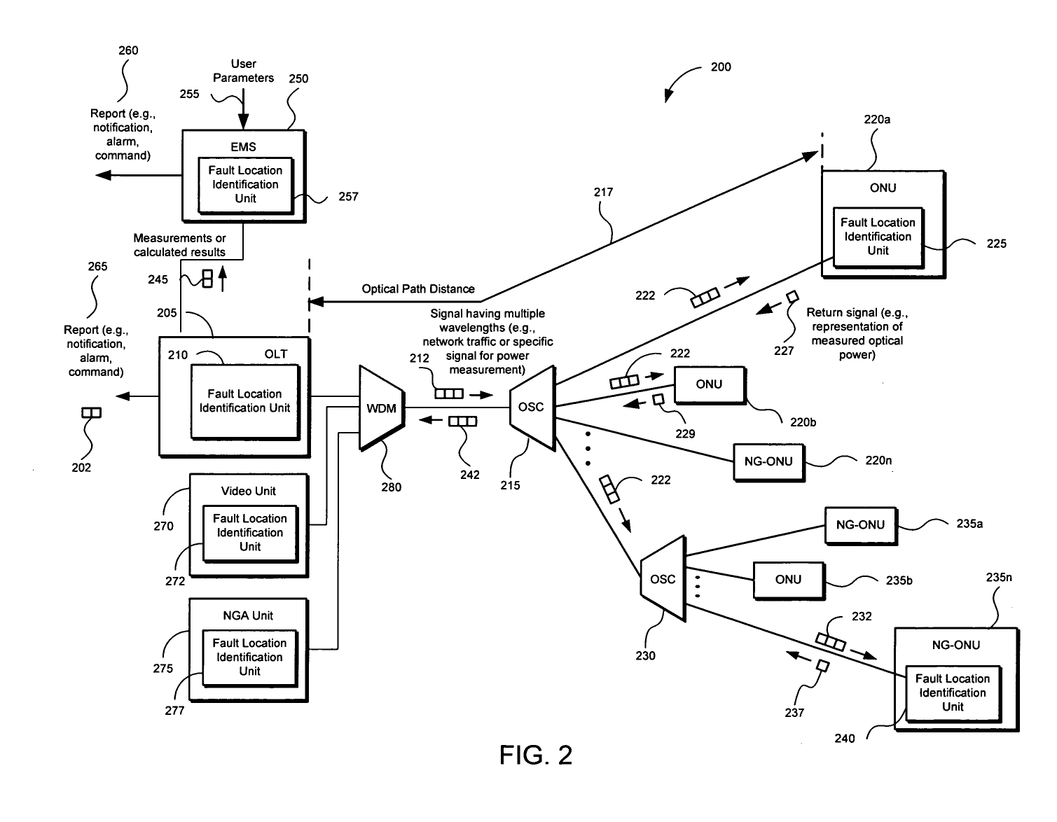

FIG. 2 is a detailed block diagram of a PON 200 employing fault isolation units 210, 225, 240, 272, 277 in optical network nodes 205, 220a-n, 235a-n, 270, 277, respectively, according to an example embodiment of the invention. In this embodiment, optical signal power loss for multiple wavelengths are determined and may be used to isolate the location of a fault in the PON. Optical signal power loss as used herein, represents the excess optical power loss across the PON, and may be represented in units of decibels (dB). Communications between an OLT 205, video unit 270, NGA unit 275, WDM 280, OSC 215, 230, and ONUs 220a-n, 235a-n may be conducted similar to that as described above in reference to FIG. 1. Continuing to refer to FIG. 2, the OLT 205, video unit 270, NGA unit 275 illustrate example transmitting network nodes, and ONU 220a-n, 235a-n illustrate example receiving network nodes, according to an example embodiment of the present invention.

It should be noted that the OLT 205, video unit 270, and NGA unit 275 may be separate components or they may be one or more components combined in a single unit and may be located in the same location, such as a central office. If combined, there may be one or more fault isolation units 210, 272, 277.

Communication signals 202 are transmitted between the OLT 205 and a WAN (not shown). Video signals may be transmitted between the video unit 270 and a video head-end unit (not shown). A transmitting optical network node, such as an OLT 205, transmits optical signals 212 to an OSC 215. After splitting and flowing through the OSC 215, the optical signals 222 continue to flow to a receiving optical network node, such as ONUs 220a-n. The OLT 205 and/or the ONUs 220a-n may include fault isolation units 210, 225, 240 configured to measure the optical signal power loss and to isolate the location of a network fault.

In operation, the OLT 205, video unit 270, and NGA unit 275 propagate optical communications signals using different wavelengths (e.g., λ₁₋₃) to the WDM 280 where they are multiplexed together and the resulting optical signal 212 is communicated to the OSC 215. The fault isolation unit 210 measures the transmitted optical power of each wavelength generated by the OLT as part of the downstream optical signal, and may be measured using a fault isolation unit local to each component, or using a single fault isolation unit resident within a single component (e.g., OLT 210) if so configured. After passing through the OSC 215, the signal 222 continues to flow to the ONUs 220a-n. Optionally, the signal 222 may also flow to another OSC 230 to be further split and the resulting signal 232 is propagated to additional ONUs 235a-n. The ONUs 220a-n, 235a-n may contain a fault isolation unit 225, 240 or a transmit/receive power measurement unit (not shown) to measure the received optical power of the same optical signal 222, 232. The received optical signal power measurement may then be transmitted via an upstream signal 227, 229, 237 (e.g., via a management channel) using a particular wavelength (e.g., 1310 nm shown as λ₄). The upstream signals 227, 229, 237 are combined at the OSC 215, 230 and the combined signal 242 is then transmitted back to the OLT 205 via optical signal 242.

The fault isolation unit 210, 225, 240, 272, 277 may also include intelligence to calculate an optical signal power loss measurement as a function of the optical path distance 217. Alternatively, another device or processor (not shown) in the OLT 205, video unit 270, NGA unit 275, or ONU 220a-n may receive power measurements from the fault isolation units 210, 225, 240, 272, 277 to calculate the optical signal power loss measurement and expected fiber attenuation as a function of the optical path distance 217.

The measured or calculated results 245 may also be communicated to an element management system (EMS) 250. The EMS 250 may accept user parameters 255 for use by the fault isolation unit 210, 225, 240 for use in calculating the optical signal power loss measurement. A report, such as a notification, alarm, or command 260, 265 may then be reported back to, for example, a system operator. Alternatively, a fault isolation unit 257 may reside in the EMS 250 or server (not shown) to perform some or all of the technique describe above.

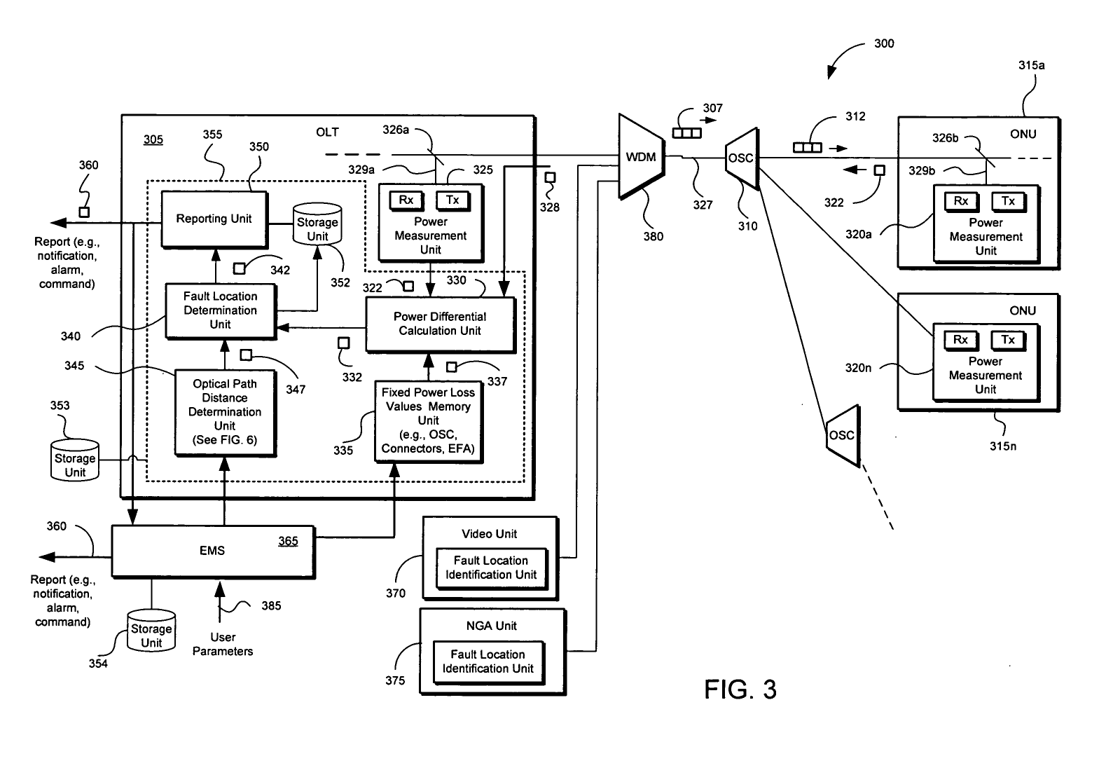

FIG. 3 is a detailed block diagram of a PON 300 further illustrating an OLT 305, video unit 370, and NGA unit 375 that include a fault isolation unit 355 and ONUs 315a-n that include transmit/receive power measurement units 320a-n according to an example embodiment of the invention. In this embodiment, optical signal power loss of a downstream optical signal 307, 312 having multiple wavelengths, flowing from the OLT 305 to the ONU 315a, is measured using the fault isolation unit 355.

The fault isolation unit 355 includes a transmit power measurement unit 325, power differential calculation unit 330, fixed power loss values memory unit 335, fault isolation determination unit 340, optical path distance determination unit 345, and reporting unit 350. The fault isolation unit 355 may also include a storage unit 352, 353 for storing measurements, calculated results, fixed power loss parameters, user parameters, and the like.

An optical signal 307 flows downstream through an OSC 310 to a plurality of ONUs 315a-n via an optical path 327. The transmit power of the optical signal 307 is measured using the transmit power measurement unit 325 by, in this example embodiment, employing a beam splitter 326a to direct a small percentage of the optical signal 307 to the transmit power measurement unit 325 via an optical path 329a. The transmit power measurement result 322 is communicated to the power differential calculation unit 330. The optical signal 307, 312 also flows through the optical distribution network to the ONUs 315a-n. The receive power of the same optical signal 312 may be measured by at least one of the plurality of ONUs 315a-n by a receive power measurement unit 320a-n, again by employing a beam splitter 326b and optical path 329b. In some embodiments, during upstream communications, the receive power measurement is communicated, for example, through a management channel, via the OSC 310 back to the OLT 305. The receive optical power measurement 328 is then communicated via an upstream communications signal 322 to the power differential calculation unit 330, where the difference between the transmitted optical signal power 322 and the receive optical signal power 328 is calculated.

Optionally, a user may provide a number of parameters 385 including fixed power loss values 337 via, for example, an EMS 365, which may be stored in a fixed power loss values memory unit 335 or in a storage unit 354 for later processing. Fixed power loss values 337 may include power losses experienced as an optical signal flows through the at least one OSC 310 and/or power losses associated with connectors (not shown) used within the PON 300. In addition, fixed power loss values may also include expected fiber attenuation (discussed below in further detail). The fixed power loss values memory unit 335 may communicate the fixed power loss values 337 to the power differential calculation unit 330 where they may be subtracted from the measured power differential value to determine a calculated power differential 332 that represents the optical power drop across an optical path between transmitting and receiving optical network nodes of the PON 300.

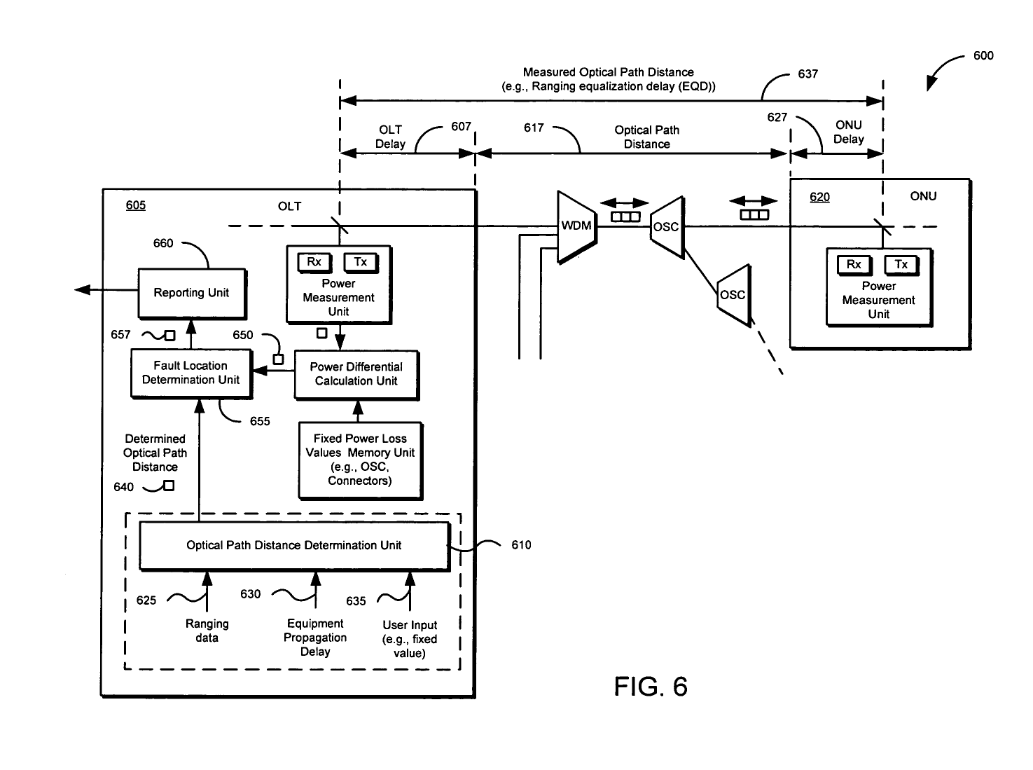

The calculated power differential value 332 is communicated to the fault isolation determination unit 340. The optical path distance determination unit 345 (described below in further detail in conjunction with FIG. 6) communicates an optical path distance value 347 to the fault isolation determination unit 340. Now that the transmit power, receive power, fixed power losses, and optical path distance are known, the fault isolation determination unit 340 can calculate the excess optical signal power loss.

Excess optical signal power loss represents the unexpected power loss across the PON 300. The fault isolation determination unit 340 calculates excess optical signal power loss as a function of the difference between the measured power differential and the expected fiber attenuation. For example, the power differential may be calculated using the following formula:

power_differential=(transmitted_power−fixed_power_losses)−received_power

The power differential is further adjusted to account for “expected fiber attenuation.” Expected fiber attenuation is a parameter that is typically provided by a fiber manufacturer and represents the power loss of an optical signal, per kilometer, as the signal propagates through the fiber, and is expressed in units of dB/km. The expected fiber attenuation is multiplied by distance, converting it to a power value expressed in units of dB, and may be subtracted from the power differential. Thus, the signal power loss may be calculated using the following formula:

signal_power_loss=power_differential−(expected_fiber_attenuation*distance)

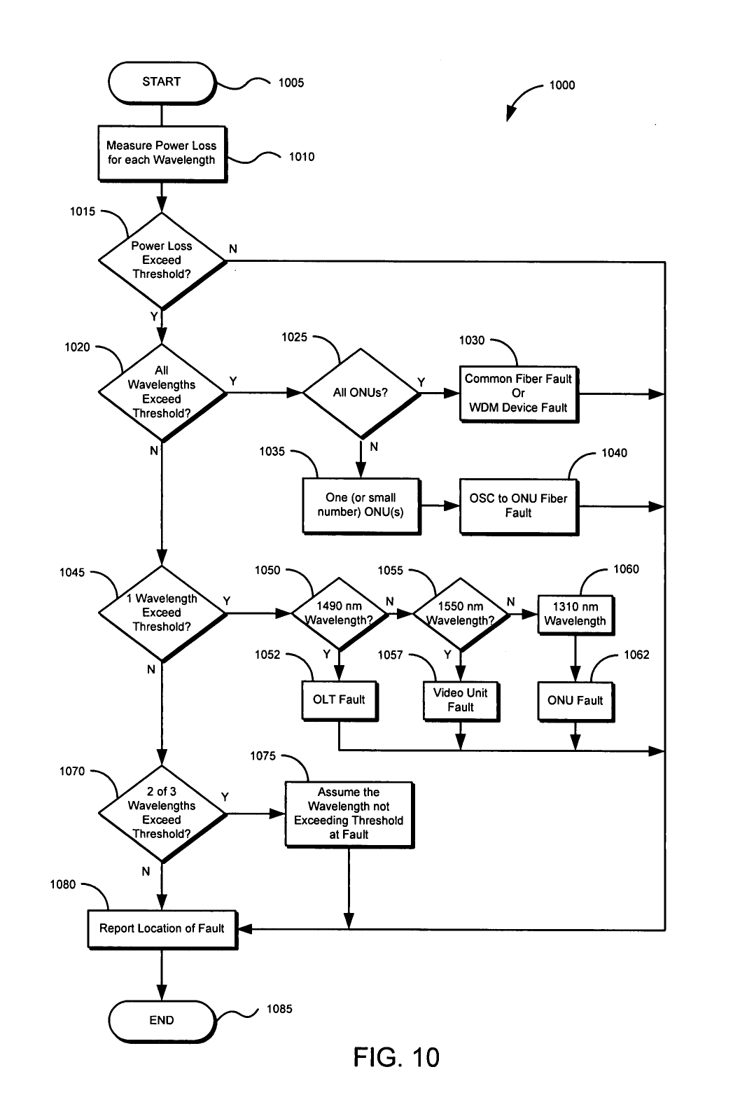

In this example embodiment, the expected fiber attenuation value may be provided by a user and stored in, for example, the fixed power loss values memory unit 335. The expected fiber attenuation value and/or other fixed power losses 337 may then be communicated to the power differential calculation unit 330 where the power differential is calculated. The calculated power differential and the expected fiber attenuation values 332 may then be communicated to the fault isolation determination unit 340. The expected fiber attenuation value is then multiplied by the optical path distance 347 which converts the value to dB and the resulting value is then subtracted from the power differential to determine the signal power loss. The signal power loss value may be used to isolate a location of a fault using a method discussed below in reference to FIG. 10, and the fault location may then be communicated to a reporting unit 350. As described above, the reporting unit 350 may report a notification, alarm, or command 360 to, for example, a system operator. Alternatively, or in addition, a report or alert may be generated when the signal power loss crosses a threshold value.

An optical signal power loss measurement may be performed for each of the ONUs 320a-n since the optical path to the ONUs 320a-n may be physically different for each ONU 320a-n. The optical signal power loss result for each ONU 320a-n or fault location 342 may be communicated to a reporting unit 350. The reporting unit 350 may report, for example, a notification, alarm, or command 360 to, for example, a system operator (not shown). In addition, or alternatively, the report 360 may be communicated to, for example, a WAN (not shown) using the communications signals 112 as described above in FIG. 1.

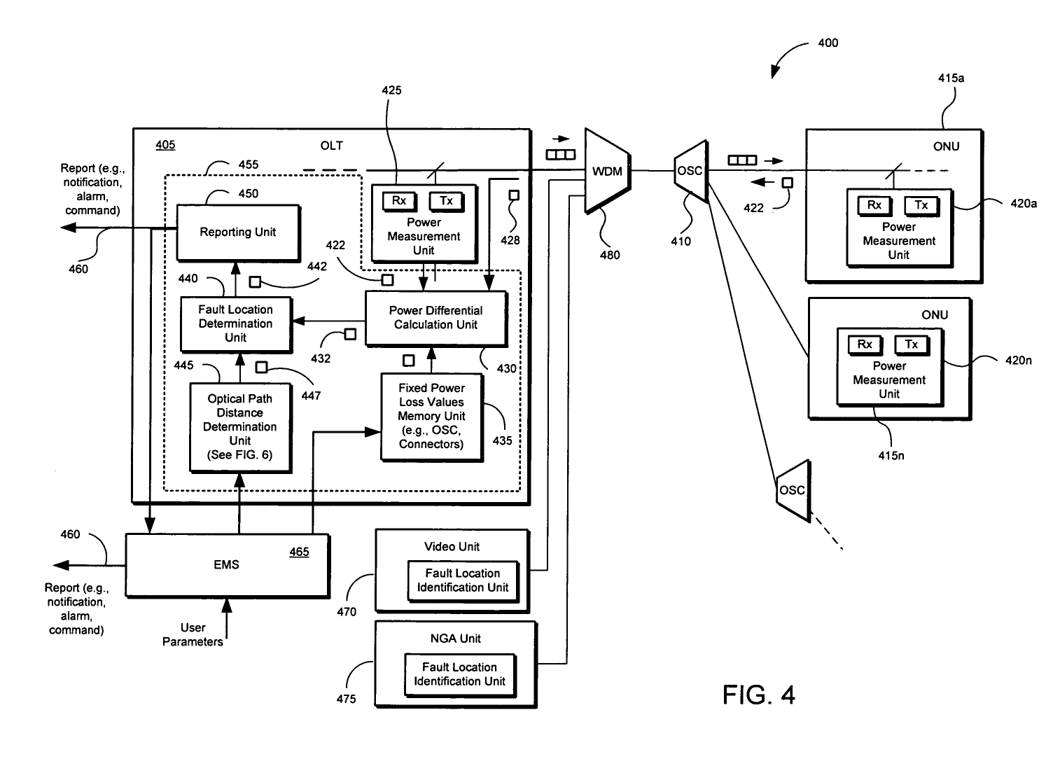

FIG. 4 is a detailed block diagram of a PON 400 illustrating an OLT 405 that includes a fault isolation unit 455 and ONUs 415a-n which include transmit/receive power measurement units 420a-n according to an example alternative embodiment of the present invention. However, in this embodiment the optical signal power loss of an optical path is measured using an upstream optical signal 422 flowing from the ONUs 415a-n back to the OLT 405.

In this example embodiment, the ONU 415a transmits an upstream optical signal 422 using a different wavelength (e.g., 1310 nm) than that of the downstream signal. The signal 422 flows upstream to an OSC 410 and may be combined with other upstream optical signals from other ONUs 415n. The transmit power of the upstream wavelength of the optical signal 422 is measured using the appropriate transmit power measurement units 420a-n in the respective ONUs 415a-n. The transmit power measurement value 428 may be communicated back to the OLT 405 via an upstream management channel where the transmit power measurement value 428 is further communicated to the power differential calculation unit 430.

The receive optical power of the same upstream wavelength of the optical signal 422 is measured by the receive power measurement unit 425 in the OLT 405, video unit 470, or NGA unit 475, depending on which unit the wavelength is directed to. The received optical power measurement value 422 is communicated to the power differential calculation unit 430 where the difference between the transmitted optical signal power 428 and the receive optical signal power 422 is calculated. Optionally, a user may provide a number of parameters including fixed power losses 435 via, for example, an EMS 465. Fixed power loss values 435 may include power losses incurred as a signal flows through the at least one OSC 410, power losses associated with connectors (not shown) used within the PON 400, and/or power losses associated with expected fiber attenuation as a function of distance. These fixed power loss values may be subtracted from the measured power differential value to determine a calculated power differential 432 which represents the optical power drop across the PON 400.

The calculated power differential 432 is communicated to the fault isolation determination unit 440. An optical path distance 447 is also communicated to the fault isolation determination unit 440 via an optical path distance determination unit 445, which will be described below in further detail in conjunction with FIG. 6. The fault isolation determination unit 440 calculates optical signal power loss by subtracting expected fiber attenuation as a function of optical path distance 447 using the formula described above and may isolate the location of a network fault using the method described in, for example, FIG. 10.

Continuing to refer to FIG. 4, the optical signal power losses or fault location 442 may be communicated to a reporting unit 450. The reporting unit 450 may report, for example, a notification, an alarm, or a command 460, to, for example, a system operator (not shown). In addition, or alternatively, the report 460 may be communicated to, for example, a WAN (not shown) using the communications signals 110 as described above in FIG. 1.

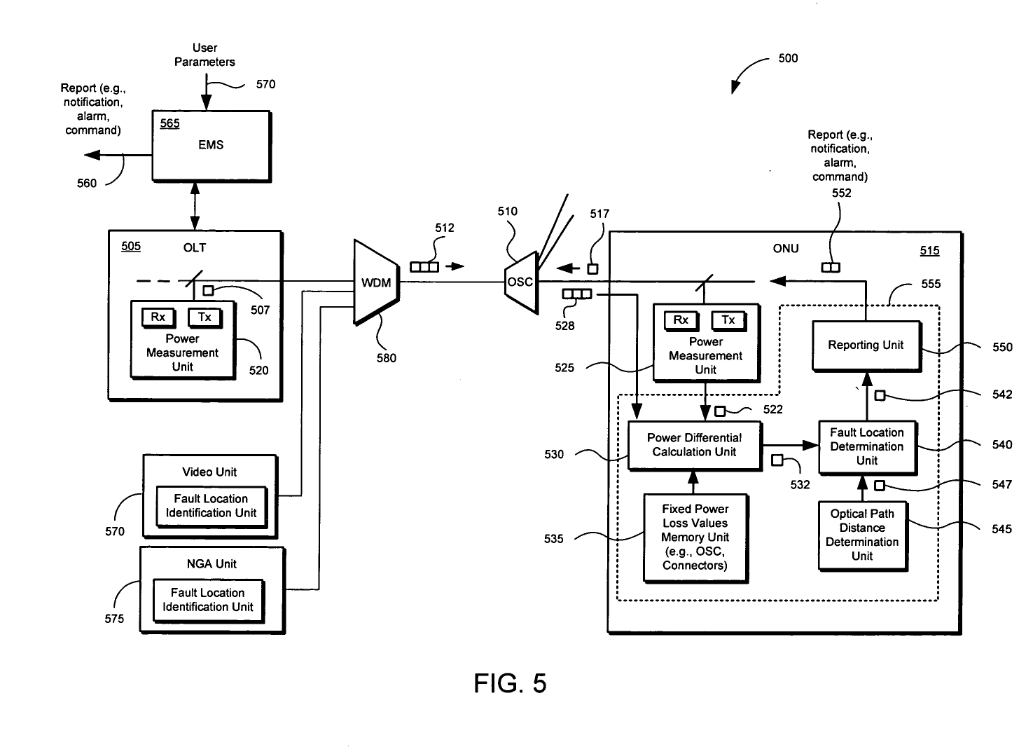

FIG. 5 is a detailed block diagram of a PON 500 employing an alternative example embodiment of the invention. In this example embodiment, the optical signal power loss and location of a network fault is identified using a downstream optical communication signal 512 having multiple wavelengths and is calculated at an ONU 515.

A WDM 580 transmits a downstream optical signal 512 having multiple wavelengths from an OLT 505, video unit 570, and/or an NGA unit 575 to at least one ONU 515 via at least one OSC 510. The ONU 515 may contain a fault isolation unit 555 such as the fault isolation unit 455 described above in conjunction with FIG. 4. The transmit power 507 for each wavelength of the optical signal 512 is measured by a transmit power measurement unit 520 at the OLT 505 and a representation of the result is transmitted to the power differential calculation unit 530 in the ONU 515 via a downstream management channel. A receive power 522 for each wavelength of the same optical signal 528 is measured at the ONU 515 by a receive power measurement unit 525 and further communicated to the power differential calculation unit 530.

The power differential calculation unit 530 then calculates the difference between the transmit optical power 507 and the receive optical power 522 for each wavelength. Optionally, a user may provide a number of user parameters 570 including fixed power loss values 535 via, for example, an EMS 565 that may be communicated to the fault isolation determination unit 555 via a network traffic communications signal such as the optical signal 512. Fixed power loss values 535 may include power losses incurred as a signal flows through the at least one OSC 510 and/or power losses associated with connectors (not shown) used within the PON 500. The fixed power losses 535 may be used to calculate the power differential value 532 which represents the optical power drop across the PON 500.

The calculated power differential value 532 is communicated to the fault isolation determination unit 540. The optical path distance 547 for that particular ONU 515 is also communicated to the fault isolation determination unit 540 via an optical path distance determination unit 545. An optical signal power loss measurement value 542 is determined using a calculation such as that described above in conjunction with FIG. 2 and a fault location is determined using the technique described below in conjunction with FIG. 10. Continuing to refer to FIG. 5, the optical signal power loss measurement value or fault location 542 may be communicated to the reporting unit 550. The reporting unit 550 may then communicate a report, measurements, calculated results 552, or any combination thereof, to, for example, an EMS 565, a service provider (not shown), or the transmitting optical node, such as the OLT 505 via an upstream communications signal 517.

In another alternative example embodiment of the invention, the optical signal power loss between the OLT 505, video unit 570, or NGA 575 and the ONU 515 may be measured using an upstream optical signal 517. In this embodiment, the transmitted and received power differential of the upstream optical signal 517 is determined at the ONU 515. It should be noted that some or all the wavelengths may be measured simultaneously or individually by some or all of the upstream components (i.e., the OLT 505, video unit 570, or NGA 575).

The ONU 515 transmits an upstream signal 517 to an OLT 505, video unit 570, or NGA 575 via at least one OSC 510 and the WDM 580. The transmit power of the upstream optical signal 517 is measured by a transmit power measurement unit 525 located in the ONU 515 and the result 522 is communicated to the power differential calculation unit 530. The receive power measurement 507 of the same wavelength in the same upstream optical signal 517 is measured at the OLT 505, video unit 570, or NGA 575 by a receive power measurement unit 520. The received optical power measurement 507 is then communicated back to the ONU 515 using a downstream communications signal 512 and then on to the power differential calculation unit 530 within the fault isolation unit 555. Previous or subsequent upstream signal power loss values for each upstream wavelength may also be communicated to the ONU 515 using a downstream communications signal 512.

The power differential calculation unit 530 then calculates the difference between the transmitted optical power 522 and the received optical power 507 of the same optical signal 517. Similarly, a user may optionally provide fixed power losses 535 representing various losses incurred in the PON 500. These losses may be communicated to the power differential calculation unit 530 for use in calculating the power differential 532.

The calculated power differential result 532 is then communicated to the fault isolation determination unit 540. The determined optical path distance 547 is also communicated to the fault isolation determination unit 540 via the optical path distance determination unit 545 for use in calculating expected fiber attenuation. An optical signal power loss measurement value 542 is determined and communicated to the reporting unit 550. Using the optical signal power loss value for multiple wavelengths, a fault location may also be determined and communicated to the reporting unit 550. The reporting unit 550 may then communicate a report, or measurements, or calculated results 552, or any combination thereof, to, for example, an EMS 565, a service provider (not shown), or the OLT 505. As used herein, a service provider may be represented more specifically as a technician, for example, viewing a user-interface such as an EMS or Network Management System (NMS) or monitor connected to the OLT, or may be represented more generally as a system operator receiving a report.

FIG. 6 is a detailed block diagram illustrating in further detail a PON 600 employing an example embodiment of a network node, such as an OLT 605, that includes an optical path distance determination unit 610. As discussed above, optical signal power loss is determined by subtracting out expected fiber attenuation as a function of distance. The optical path distance 617 represents the distance between a transmitting network node, such as an OLT 605, and a receiving network node, such as an ONU 620.

The optical path distance 617 may be determined using ranging data 625. The ranging process, such as that described in International Telecommunications Union-Telecommunication (ITU-T) G.984.3 (2004), is a technique of measuring the logical distance between each ONU and its associated OLT to determine the optical path propagation time such that upstream data sent from one ONU on the same PON does not collide with data sent from a different ONU. The measured logical optical path distance 637 is also referred to as the equalization delay (EQD) and is used interchangeably herein.

The EQD 637 returned by the ranging process is very accurate—in the order of a few upstream bit-times. For example, in a gigabit PON the upstream bit length is about 0.8 nanoseconds which translates to about 16 centimeters of light propagation through a fiber. Therefore, measurement to a byte level is about 1 meter accurate in a PON 600 that may be, for example, 10 kilometers in length.

However, the EQD 637 also includes equipment propagation delays within the network nodes. The equipment propagation delay 630 may include, for example, an OLT propagation delay 607 and an ONU propagation delay 627. These values may also vary between different equipment vendors. These delay may be accounted for by assuming a fixed delay within the network node of, for example, 20 meters in distance or about 100 nanoseconds. Alternatively, if the equipment delays 607, 627 are larger that a few tens of meters, the distance may be calibrated by, for example, comparing the EQD 637 of a reference ONU 620 with a know fiber length measured at a known temperature.

The measured EQD 637 and the equipment propagation delay 630 are communicated to the optical path distance determination unit 610 where the EQD is converted from bits to a representation of distance in kilometers. Thus, the optical path distance 617 may be determined using the following formula:

$$optical\_path \_distance = \frac{EQD - ( OLT\_delay + ONU\_delay )}{2}$$

The delays are divided by 2 because they represents the round trip delay which includes the downstream and upstream propagation time.

Alternatively, a system operator may provide a determined optical path distance 640 as user input 635 via, for example, an EMS (not shown). This may be a fixed value such as a distance measured during deployment of the PON, a test value, a calculate value, etc.

Similar to that described above in FIG. 3, the determined optical path distance 640 and the calculated power differential 650 are communicated to the fault isolation determination unit 655. The determined optical signal power loss value 657 may be communicated to the reporting unit 660 and/or an EMS (not shown). Note that the optical path distance determination technique described above similarly apply to a video unit or NGA unit (not shown).

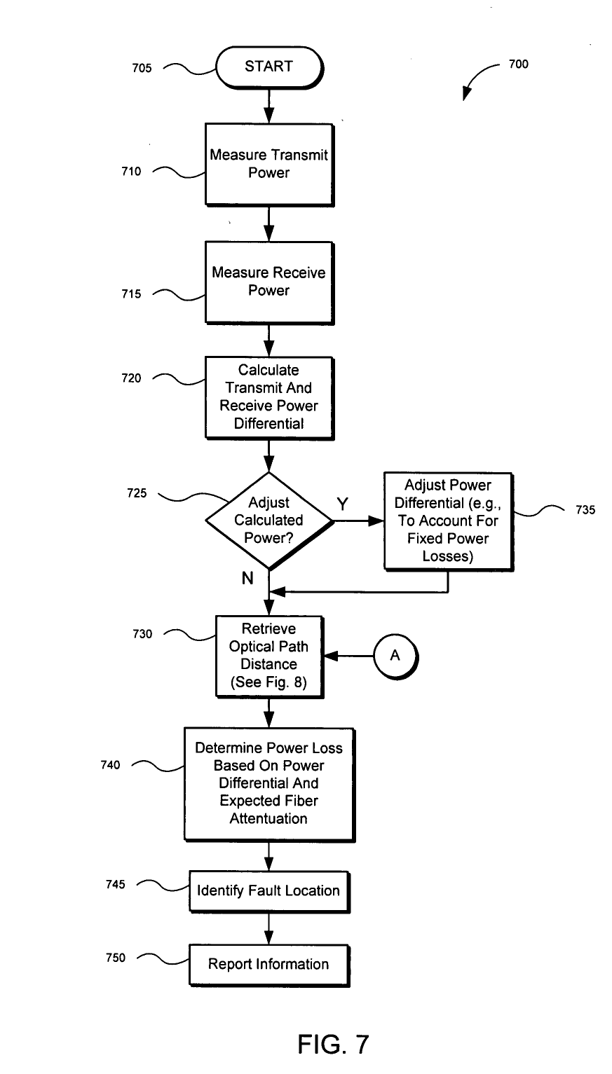

FIG. 7-10 illustrate, in the form of a flow diagrams, exemplary embodiments of the present invention. It should, however, be evident that various modifications and changes may be made thereto without departing from the broader spirit and scope of the present invention. For example, some of the illustrated flow diagrams may be performed in an order other than that which is described. It should be appreciated that not all of the illustrated flow diagrams are required to be performed, that additional flow diagram(s) may be added, and that some may be substituted with other flow diagram(s).

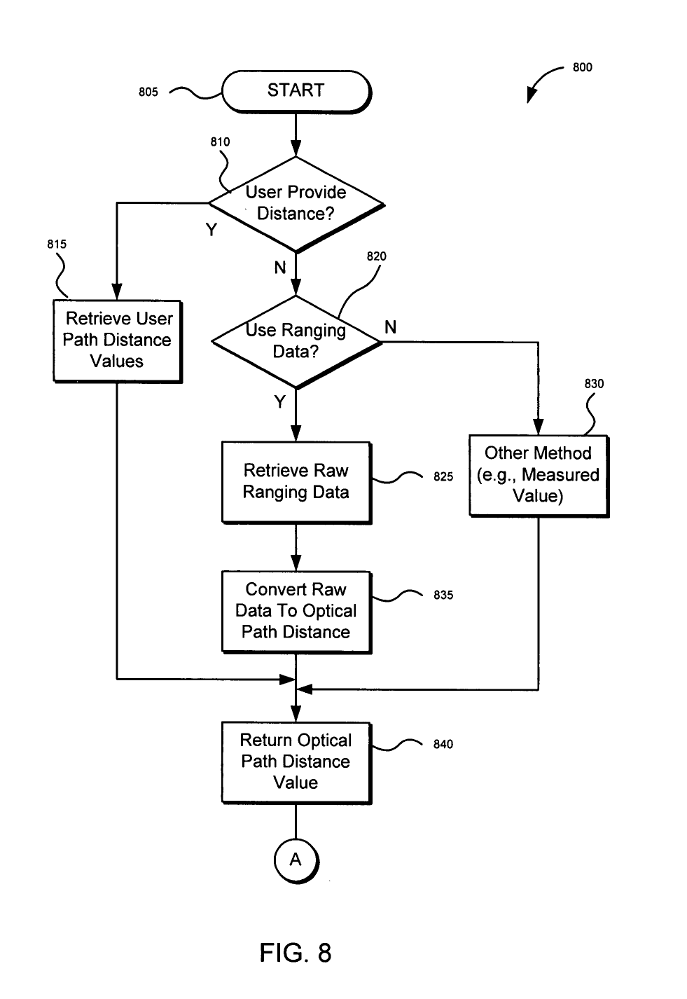

FIG. 7 is an example flow diagram of a process 700 illustrating an embodiment of the present invention. The process 700 starts (705) and a transmitting optical network node measures a transmit optical power (710) for each wavelength of an optical signal. A receiving optical network node measures a receive optical power (715) for each wavelength of the same optical signal. A calculating unit calculates a power differential (720) between the transmit and receive optical power measurements for each wavelength. If the calculated power is to be adjusted (725), the process 700 adjusts the power differential, for example, to account for fixed power losses (735). The process 700 retrieves a determined optical path distance (730) as described below in further detail in conjunction with FIG. 8. An optical signal power loss may be determined by calculating the power differential and subtracting the expected fiber attenuation as a function of optical path distance (740). The determined optical power loss result may be reported (745) to, for example, a system operator or EMS, or may be further used in conjunction with, for example, the flow diagram described below in FIG. 10 where power loss measurements are examined (1010) in order to isolate the location of a network fault.

FIG. 8 is an flow diagram of a process 800 to determine an optical path distance according to an example embodiment of the invention. The process 800 starts (805) and if a user provides optical path distance information (810) the process 800 retrieves the user provided values (815). If not, the process 800 determines if ranging data is to be used (820), and if so, the process 800 retrieves raw ranging data (825) and converts it from, for example, bits to a representation of optical path distance (835). If not, the process 800 may use other methods as described above in FIG. 6. The process 800 returns the determined optical path distance value (840) to the calling process, for example, ‘A’ as shown in FIG. 7.

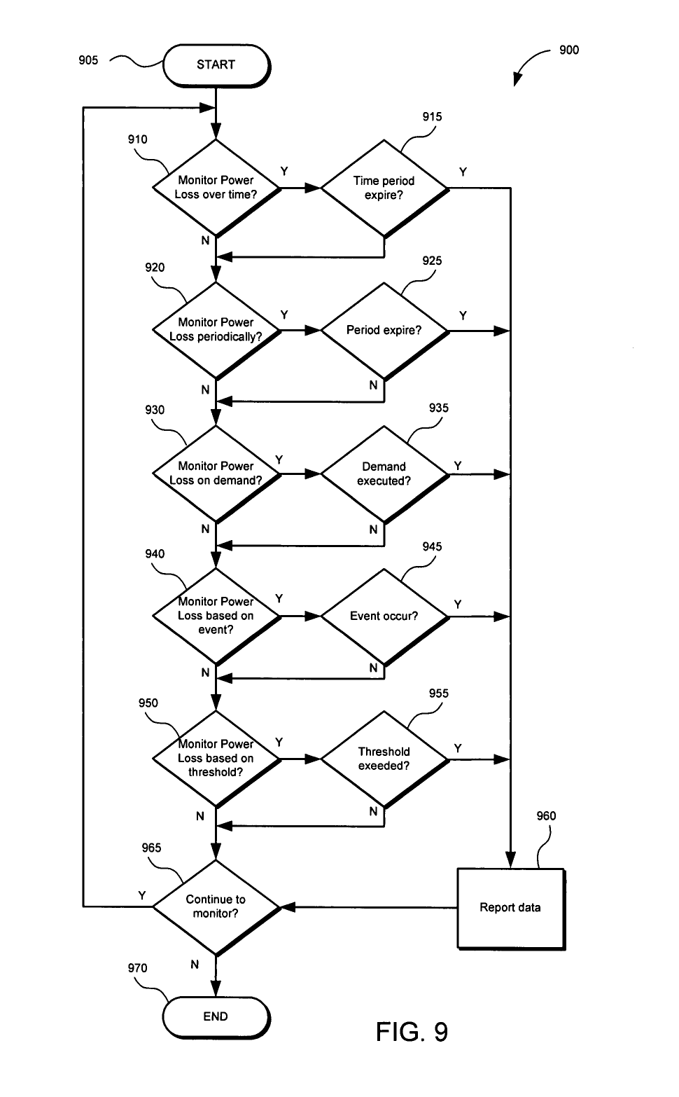

FIG. 9 is an example flow diagram illustrating a process 900 to report data indicative of an optical signal power loss according to an example embodiment of the invention. At least one monitoring method may be used to report data. The process 900 starts (905) and determines whether to monitor power loss over a particular time period (910) and if so, whether the time period has expired (915). If the time period has expired (915), the process 900 reports the data (960). Monitoring power loss over time may allow a system operator to detect and/or predict optical path degradation that occurs over short and long time periods, allowing the system operator to, for example, proactively maintain a PON, thereby reducing or preventing communications errors and service outages.

Next, the process 900 determines whether to monitor power loss periodically (920) and if so, whether the period has expired (925). If the period has expired (925), the process 900 reports the data (960). The process 900 then determines whether to monitor power loss on-demand (930) and if so, whether the demand was executed (935). If the demand has executed (935), the process 900 reports the data (960). The process 900 continues and determines whether to monitor power loss on an event-driven basis (940) and if so, whether the event has occurred (945). If the event has occurred (945), the process 900 reports the data (960). The process 900 continues further and determines whether to monitor power loss based on a threshold preconfigured by, for example, a service provider (950) and if so, whether the data exceeds the threshold (955). If the data exceeds the threshold (955), the process 900 reports the data (960). The process 900 then determines whether to continue to monitor the power loss data, and if so, continue with step 910 to repeat the process. If not, the process 900 ends (970).

FIG. 10 illustrates a flow diagram of a process 1000 for determining a location of a fault in an optical network according to an example embodiment of the present invention. The process 1000 starts (1005) and examines measured power loss values for multiple wavelengths across a PON using a technique such as that described above in conjunction with FIG. 7. The resulting power loss measurement may be compared to a threshold (1015) and if below the threshold (or above if so configured) the process 1000 may report that there is no fault (1080) and the process 1000 ends (1085).

If excess power loss is detected, e.g., exceeds a threshold, the process 1000 determines if all wavelengths exceed the threshold (1020). If so, the process 1000 then determines if all wavelengths for all ONUs exceed the threshold (1025), and if so, the most likely cause of the fault is a common fiber fault (e.g., fiber aging or excessive bending) or WDM device fault (1030) and is reported as such (1080). If all wavelengths on only one ONU (or a small number of ONUs) (1035) exceeds the threshold, the fault is most likely related to a fiber fault associated with the path between the OSC and the identified ONU (1040). In either case, the process 1000 may report a location of the fault (1080) and the process 1000 ends (1085).

If only one wavelength exceeds the threshold (1045), the fault is most likely a component related fault (e.g., OLT, Video Unit, or NGA unit) or a fiber fault related to a fiber link unique to each component (e.g., the fiber connecting the component to the WDM 280). The process 1000 determines which wavelength exceeds the threshold in order to determine which component may be at fault. For example, in the case of three wavelengths, if the 1490 nm wavelength exceeds the threshold (1050), the OLT is most likely at fault (1052). If the 1550 nm wavelength exceeds the threshold (1555), the video unit is most likely at fault (1057). If the 1310 nm wavelength is exceeds the threshold (1060), the ONU is most likely at fault (1062). Similarly, if the system comprises an NGA unit, and its associated wavelengths (e.g., 1580-1625 nm) exceed the threshold, the NGA unit is most likely at fault. The process 1000 may then report the location of the fault (1080) and the process 1000 ends (1085).

The case where two of three wavelengths exceed a threshold (1070) is an unusual situation and should be relatively rare. However, if this does occur, the process 1000 may assume the wavelength not exceeding threshold is at fault (1075) and follow the method as described above (e.g., instructions 1045-1062) in order to isolate a location on the faulty component. The process 1000 reports the location of the fault (1080) and ends (1085).

Some or all of the steps in the process 1000 may be implemented in hardware, firmware, or software. If implemented in software, the software may be (i) stored locally with the OLT, ONU, video unit, NGA unit, or some other remote location such as a server or the EMS, or (ii) stored remotely and downloaded to the OLT, ONU, video unit, NGA unit, or the EMS during, for example, start 1005. The software may also be updated locally or remotely. To begin operations in a software implementation, the OLT, ONU, video unit, NGA unit, server, or EMS loads and executes the software in any manner known in the art.

It should be apparent to those of ordinary skill in the art that methods involved in the invention may be embodied in a computer program product that includes a computer readable medium. For example, such a computer readable medium may be a read-only memory device, such as a CD-ROM disk or convention ROM devices, or a random access memory, such as a hard drive device, computer diskette, or memory having a computer readable program code stored thereon. The computer may load the program code and execute it to perform some or all of the example operations described herein or equivalents thereof.

While this invention has been particularly shown and described with references to example embodiments thereof, it will be understood by those skilled in the art that various changes in form and details may be made therein without departing from the scope of the invention encompassed by the appended claims.

What is claimed is:

1. A method of isolating a location of a fault in an optical network, the method comprising:
calculating power differentials between transmitted optical powers of multiple wavelengths and received optical powers of the same multiple wavelengths to produce calculated power differentials, the transmitted optical powers measured at a transmitting optical network node and the received optical powers measured at a receiving optical network node in communication with the transmitting optical network node via at least one optical path in an optical network;
determining optical power losses based on a combination of the calculated power differentials and fiber attenuation as a function of an optical path distance between the transmitting and receiving optical network nodes for the multiple wavelengths;
isolating a location of a fault in the optical network based on differences between the optical power losses of the multiple wavelengths; and
reporting the location of the fault.

2. The method according to claim 1 wherein calculating the power differentials includes adjusting the calculated power differentials to account for fixed power losses between the transmitting and receiving optical network nodes.

3. The method according to claim 2 further including accepting parameters related to the fixed power losses from a user and applying the parameters in adjusting the calculated power differentials.

4. The method according to claim 1 wherein the optical wavelength is a traffic signal carrying network communications.

5. The method according to claim 1 further including calculating the optical path distance between the transmitting and receiving optical network nodes based on ranging parameters determined during a ranging of the receiving optical network node or the transmitting optical network node.

6. The method according to claim 5 wherein calculating the optical path distance includes removing propagation delays within the transmitting and receiving optical network nodes from the optical path distance.

7. The method according to claim 1 further including accepting parameters from a user related to the optical path distance and applying the parameters in determining the optical wavelength power losses.

8. The method according to claim 1 further including:
forwarding a representation of the optical powers measured at the receiving optical network node from the receiving optical network node to the transmitting optical network node; and
wherein determining the optical wavelength power losses is performed at the transmitting optical network node.

9. The method according to claim 1 further including:
forwarding representations of optical powers, a representation of optical power losses, or both, of the multiple wavelengths from the transmitting optical network node to at least one of the following nodes: a management node, server, service provider, or the receiving optical network node; and
wherein isolating a location of the fault is performed at the at least one node receiving the representations of optical powers, representation of optical power losses, or both.

10. The method according to claim 1 further including:
forwarding a representation of the transmitted optical powers from the transmitting optical network node to the receiving optical network node; and
wherein determining the optical wavelength power losses is performed at the receiving optical network node.

11. The method according to claim 1 further including:
forwarding representations of optical powers, a representation of optical power losses, or both, from the receiving optical network node to at least one of the following nodes: a management node, server, service provider, or the transmitting optical network node; and
wherein isolating a location of the fault is performed at the at least one node receiving the representations of optical powers, representation of optical power losses, or both.

12. The method according to claim 1 further including monitoring for a change in the optical wavelength power losses over time and reporting the change in an event a change is identified.

13. The method according to claim 1 wherein determining the optical wavelength power losses is performed periodically, aperiodically, on an on-demand basis, or on an event driven basis.

14. The method according to claim 1 wherein reporting the location of the fault further includes alerting a service provider if the optical wavelength power loss exceeds a threshold.

15. The method according to claim 1 wherein reporting the location of the fault further includes at least one of the following actions: issuing an alarm, causing the transmitting or receiving optical network node to change states, issuing a command, issuing a notification, issuing a threshold crossing alert, reporting a representation of the transmitted or received optical powers, reporting the calculated power differentials, or reporting an average of the optical wavelength power losses corresponding to at least two of the multiple wavelengths.

16. The method according to claim 1 wherein the transmitting optical network node is an Optical Line Terminal (OLT) and the receiving optical network node is an Optical Network Unit (ONU) downstream of the OLT.

17. The method according to claim 1 wherein the transmitting optical network node is an Optical Network Unit (ONU) and the receiving optical network node is an Optical Line Terminal (OLT) upstream of the ONU.

18. The method according to claim 1 wherein isolating a location of a fault includes isolating the location by correlating wavelength power loss values for at least two of the multiple wavelengths.

19. The method according to claim 18 wherein correlating the wavelength power loss values includes correlating a wavelength power loss value against an average wavelength power loss value of at least two of the multiple wavelengths.

20. An apparatus to isolate a location of a fault in an optical network, the apparatus comprising:
a transmit power measurement unit configured to measure transmit optical powers of multiple wavelengths at a transmit optical network node, and a receive power measurement unit configured to measure receive optical powers of the same multiple wavelengths at a receive optical network node in communication with the transmit network node via an optical path in an optical network;
a calculation unit configured to calculate power differentials between the transmit optical powers and the receive optical powers of the same multiple wavelengths;
a determination unit configured to determine optical power losses based on a combination of the calculated power differentials and fiber attenuation as a function of an optical path distance between the transmit and receive optical network nodes for the multiple wavelengths;
a fault isolation unit to isolate a location of a fault in the optical network based on the differences between the optical power losses of the multiple wavelengths; and
a reporting unit to report the location of the fault.

21. The apparatus according to claim 20 wherein the calculation unit is configured to adjust the power differentials to account for fixed power losses between the transmit and receive optical network nodes.

22. The apparatus according to claim 21 wherein the calculation unit is configured to accept parameters related to the fixed power losses from a user and apply the parameters to adjust the calculated power differentials.

23. The apparatus according to claim 20 wherein the optical wavelength is a traffic signal that carries network communications.

24. The apparatus according to claim 20 further including an optical path distance determination unit configured to determine the optical path distance between the transmit and receive optical network nodes based on ranging parameters determined during a ranging of the receive or transmit optical network nodes.

25. The apparatus according to claim 24 wherein the optical path distance determination unit is configured to remove fixed delays within the transmit and receive optical network nodes from the determined optical path distance.

26. The apparatus according to claim 24 wherein the optical path distance determination unit is configured to accept parameters from a user related to the optical path distance and apply the parameters to adjust the determined optical path distance.

27. The apparatus according to claim 20 wherein the receive optical network node is configured to forward a representation of the receive optical power to the transmit optical network node; and
the transmit optical network node is configured to determine optical wavelength power losses.

28. The apparatus according to claim 20 wherein the transmit optical network node is configured to forward representations of optical powers, a representation of optical power losses, or both, of the multiple wavelengths from the transmit optical network node to at least one of the following nodes: a management node, server, service provider, or the receive optical network node; and
wherein the at least one receive optical network node receiving the representations of optical powers, the representation of optical power losses, or both is configured to isolate the location of the fault.

29. The apparatus according to claim 20 wherein the transmit optical network node is configured to forward a representation of the transmit optical powers to the receive optical network node; and
wherein the receive optical network node is configured to determine the optical wavelength power losses.

30. The apparatus according to claim 20 wherein the receive optical network node is configured to forward representations of optical powers, a representation of optical power losses, or both, from the receive optical network node to at least one of the following nodes: a management node, server, service provider, or the transmit optical network node; and
wherein the transmit optical network node receiving the representations of optical powers, representation of optical power losses, or both is configured to isolate the location of the fault.

31. The apparatus according to claim 20 the apparatus is configured to monitor for a change in the optical wavelength power loss over time and to report the change in an event a change is identified.

32. The apparatus according to claim 20 wherein the apparatus is configured to determine the optical wavelength power losses periodically, aperiodically, on an on-demand basis, or on an event driven basis.

33. The apparatus according to claim 20 wherein the reporting unit is configured to alert a service provider if a change in the optical wavelength power losses exceeds a threshold.

34. The apparatus according to claim 20 wherein the reporting unit is further configured to execute at least one of the following actions: issue an alarm, cause the transmit or receive optical network node to change states, issue a command, issue a notification, issue a threshold crossing alert, report a representation of the transmit or receive optical powers, report the calculated power differentials, or report an average of the optical wavelength power loss corresponding to at least two of the multiple wavelengths.

35. The apparatus according to claim 20 wherein the transmit optical network node is an Optical Line Terminal (OLT) and the receive optical network node is an Optical Network Unit (ONU) downstream of the OLT.

36. The apparatus according to claim 20 wherein the transmit optical network node is an Optical Network Unit (ONU) and the receive optical network node is an Optical Line Terminal (OLT) upstream of the ONU.

37. The apparatus according to claim 20 wherein the fault isolation unit is configured correlate wavelength power losses for at least two of the multiple wavelengths to isolate the location of a fault.

38. The apparatus according to claim 37 wherein the fault isolation unit is configured correlate a wavelength power loss against an average wavelength power loss of at least two of the multiple wavelengths.

39. A method of isolating a location of a fault in an optical network, the method comprising:
calculating power differentials between a transmitted optical power of multiple wavelengths and a received optical power of the same multiple wavelengths, the transmitted optical power preconfigured by a user and the received optical power measured at a receiving optical network node in communication with the transmitting optical network node via at least one optical path in an optical network;
determining optical power losses based on a combination of the calculated power differentials and fiber attenuation as a function of an optical path distance between the transmitting and receiving optical network nodes for the multiple wavelengths;
isolating a location of a fault in the optical network based on differences between the optical power losses of the multiple wavelengths; and
reporting the location of the fault.

40. A computer program product for isolating a location of a fault in an optical network, the computer program product comprising a computer readable medium having computer readable instructions stored thereon, which, when loaded and executed by a processor, causes the processor to:
calculate power differentials between transmitted optical powers of multiple wavelengths and received optical powers of the same multiple wavelengths to produce calculated power differentials, the transmitted optical powers measured at a transmitting optical network node and the received optical powers measured at a receiving optical network node in communication with the transmitting optical network node via at least one optical path in an optical network;
determine optical power losses based on a combination of the calculated power differentials and fiber attenuation as a function of an optical path distance between the transmitting and receiving optical network nodes for the multiple wavelengths;
isolate a location of a fault in the optical network based on differences between the optical power losses of the multiple wavelengths; and
report the location of the fault.
